(19) United States
(12) Patent Application Publication
(10) Pub. No.: US 2019/0356201 A1
(43) Pub. Date: Nov. 21, 2019

(54) MOTOR AND ARMATURE THEREOF

(71) Applicant: Johnson Electric International AG, Murten (CH)

(72) Inventors: Yue LI, Hong Kong (CN); Kunlun ZHENG, Shenzhen (CN); Hongqiang ZHAO, Shenzhen (CN); Haijun HUA, Shenzhen (CN); Yaming ZHANG, Shenzhen (CN); Yingsong YE, Shenzhen (CN); Yonggang ZHANG, Shenzhen (CN)

(21) Appl. No.: 16/417,970

(22) Filed: May 21, 2019

(30) Foreign Application Priority Data
May 21, 2018 (CN) 2018 1048 8921.5

(51) Int. Cl. H02K 11/22; H02K 1/14; H02K 1/18; H02K 1/27; H02K 3/24; H02K 3/52; H02K 11/33; H02K 11/40; H02K 21/22

(52) U.S. Cl. CPC H02K 11/022; H02K 1/146; H02K 1/187; H02K 1/2786; H02K 2211/03; H02K 3/522; H02K 11/33; H02K 11/40; H02K 21/22; H02K 3/24

(57) ABSTRACT

A motor includes a stator, and a rotor rotatable to the stator. The stator includes a magnetic core, a plurality of windings, and at least one shielding member mounted to one of opposite ends of the magnetic core. The magnetic core includes a yoke portion and a plurality of teeth extending from the yoke portion. The windings are correspondingly wound on the teeth. Said at least one shielding member is grounded. The rotor and said at least one shielding member cooperatively bound a shielding space for the windings.

### CROSS REFERENCE TO RELATED APPLICATIONS

This non-provisional patent application claims priority under 35 U.S.C. § 119(a) from Patent Application No. 201810488921.5 filed in The People's Republic of China on May 21, 2018.

### FIELD OF THE INVENTION

The present invention relates to a motor, and a motor with improved electromagnetic compatibility (EMC) and an armature of the motor.

### BACKGROUND OF THE INVENTION

An armature of a motor includes a magnetic core, and a winding wound on the magnetic core. In operation of the motor, electromagnetic interference (EMI) is generated due to alternately changing of strength and direction of the current through the windings, resulting in an insufficient electromagnetic compatibility (EMC) level.

### SUMMARY OF THE INVENTION

One aspect of the present invention provides a motor including a stator, and a rotor rotatable to the stator. The stator includes a magnetic core, a plurality of windings, and at least one shielding member mounted to one of opposite ends of the magnetic core. The magnetic core includes a yoke portion and a plurality of teeth extending from the yoke portion. The windings are correspondingly wound on the teeth. Said at least one shielding member is grounded. The rotor and said at least one shielding member cooperatively bound a shielding space for the windings.

Preferably, said at least one shielding member includes two shielding members respectively fixed to the opposite ends of the magnetic core.

Preferably, the two shielding members are connected to each other with at least one first fastener.

Preferably, the two shielding members are connected to each other with at least one first fastener.

Preferably, the two shielding members are electrically coupled to each other with said at least one first fastener.

Preferably, said at least one first fastener comprises two first fasteners, the stator further comprises a gasket mounted between and electrically coupled to the two first fasteners.

Preferably, said at least one first fastener extends through and electrically coupled to the magnetic core.

Preferably, said at least one shielding member defines a plurality of venting holes exposing the windings for heat dissipation.

Preferably, the stator further comprises a hollow columnar hub axially extending through and fixed to a centre of the magnetic core.

Preferably, the motor further comprises a circuit board with a grounding contact, and one of said at least one first fastener is connected to the ground contact through a wire.

Preferably, said at least one shielding member is made of electrically conductive but non-magnetically permeable material.

Preferably, said at least one shielding member is made of copper or aluminum.

Preferably, said at least one shielding member is a plastic member coating with a conductive layer.

Preferably, the motor is an outer rotor brushless DC motor, the rotor comprises an annular outer casing, a plurality of permanent magnets attached to an inner wall of the outer casing, and a rotating shaft fixed to the outer casing, the stator is located in the outer casing and is movably sleeved on the rotating shaft.

Preferably, one end of the outer casing comprises a bottom wall fixed to the rotating shaft, the other end of the outer casing is open to enable the stator fitted into the outer casing therefrom.

Preferably, the motor further comprises a mounting bracket, the stator is fixed to the mounting bracket, the rotating shaft is rotatably mounted to the mounting bracket.

Preferably, the mounting bracket defines a cavity that is open at one end, the opening end of the cavity is opposite to the opening end of the outer casing.

Another aspect of the present invention provides an armature of a motor including a magnetic core, a plurality of windings, and at least one shielding member mounted to one of opposite ends of the magnetic core. The magnetic core includes a comprising a yoke portion and a plurality of teeth extending from the yoke portion. The windings are correspondingly wound on the teeth windings. Said at least one shielding member is grounded.

Preferably, the armature is a stator of a brushless motor.

Below, embodiments of the present invention will be described in detail with reference to the accompanying drawings.

### BRIEF DESCRIPTION OF THE DRAWINGS

FIG. 1 is a perspective view of a motor according to a first embodiment of the present invention;

FIG. 2 is an exploded view of the motor shown in FIG. 1;

FIG. 3 is a perspective view of a stator of the motor shown in FIG. 2;

FIG. 4 is an end plan view of the stator shown in FIG. 3;

FIG. 5 is a side plan view of the stator shown in FIG. 3;

FIG. 6 is a cross-sectional view of the stator of FIG. 5 taken along line A-A;

FIG. 7 is a perspective view of a stator of a motor according to a second embodiment of the present invention;

FIG. 8 is an end plan view of the stator shown in FIG. 7;

FIG. 9 is a cross-sectional view of the stator of FIG. 8 taken along line B-B;

FIG. 10 is a side plan view of the stator shown in FIG. 7;

FIG. 11 is a cross-sectional view of the stator of FIG. 10 taken along line C-C.

### DETAILED DESCRIPTION OF THE PREFERRED EMBODIMENTS

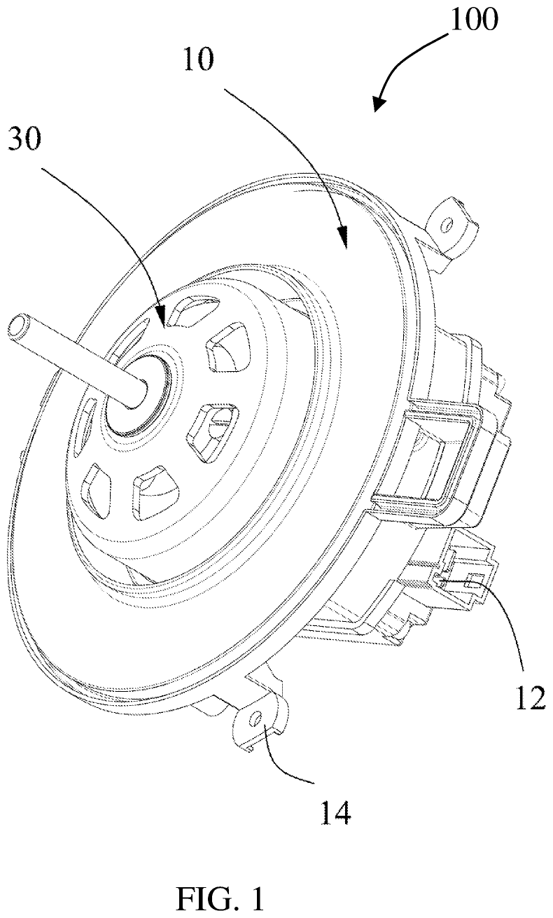

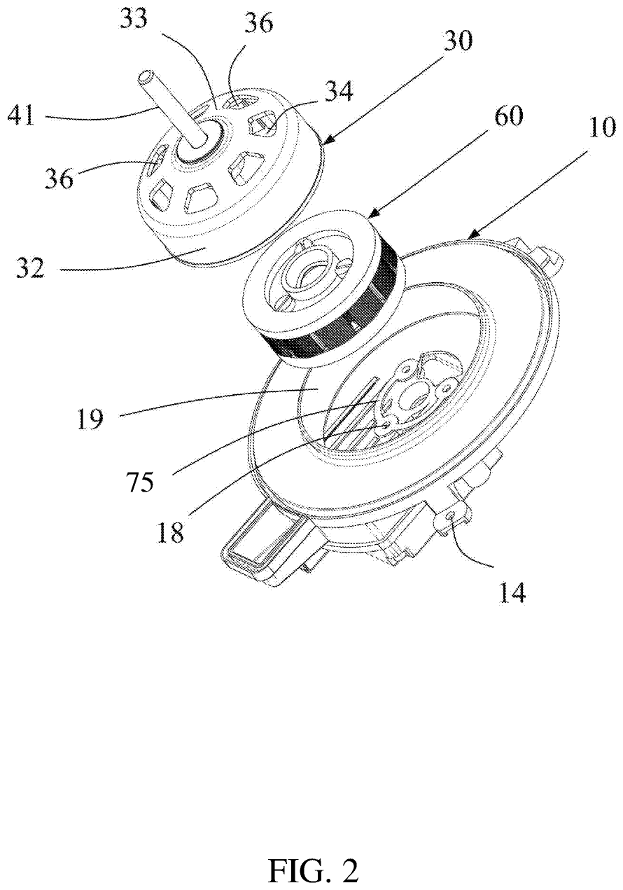

Referring to FIGS. 1 and 2, a motor 100 of a first embodiment to includes a mounting bracket 10, a stator 60 fixed to the mounting bracket 10, and a rotor 30 rotatably mounted to the mounting bracket 10 or the stator 60. A motor drive unit including a circuit board carrying a motor drive circuit, terminals 12 for connecting the circuit board to an external power source, and other electrical components can be mounted inside the mounting bracket 10. The mounting bracket 10 forms a plurality of connecting tabs 14 with mounting holes to facilitate mounting the mounting bracket 10 to the desired position. In the present embodiment, the motor 100 is a brushless DC motor, and the stator 60 is an armature of the motor 100.

It should be understood that the mounting bracket 10 can be regarded as a part of the stator 60, since the stator 60 and the mounting bracket 10 are integrally fixed.

In one embodiment, the motor 100 are outer rotor motor. The rotor 30 includes an annular outer casing 32, a plurality of permanent magnets 36 mounted to an inner wall of the outer casing 32, and a rotating shaft 41 fixed to the outer casing 32. One end of the outer casing 32 has a bottom wall 33 fixed to the rotating shaft 41. The other end of the outer casing 32 is open to enable the stator 60 fitted into the outer casing 32. The stator 60 is located in the outer casing 32 and is movably sleeved on the rotating shaft 41. The bottom wall 33 of the outer casing 23 defines one or more venting holes 34 to facilitate ventilation and heat dissipation. The rotating shaft 41 is rotatably mounted to the mounting bracket 10. Preferably, the outer casing 23 is made of highly magnetically permeable material.

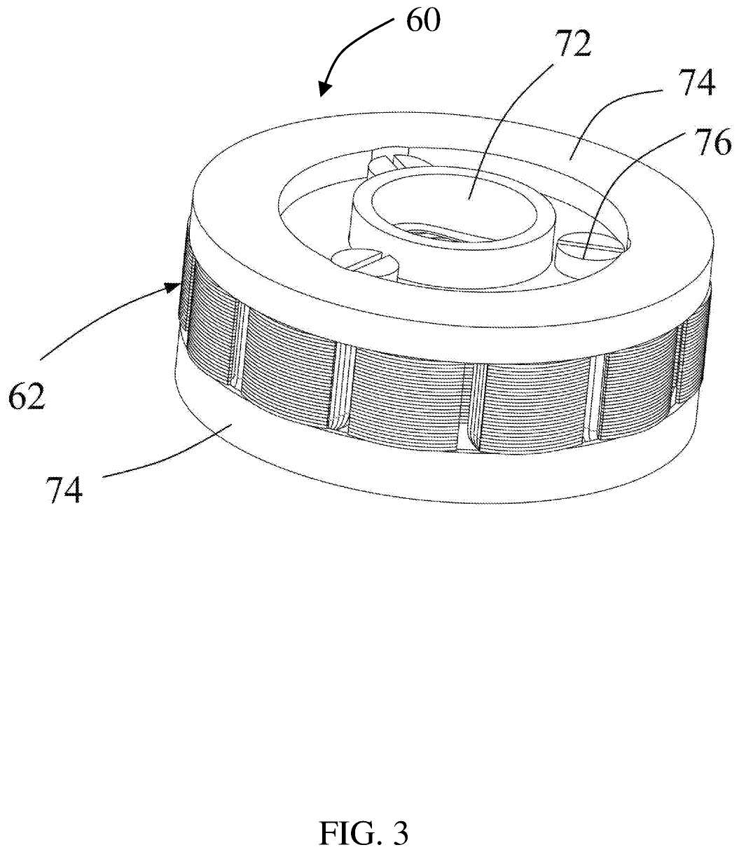

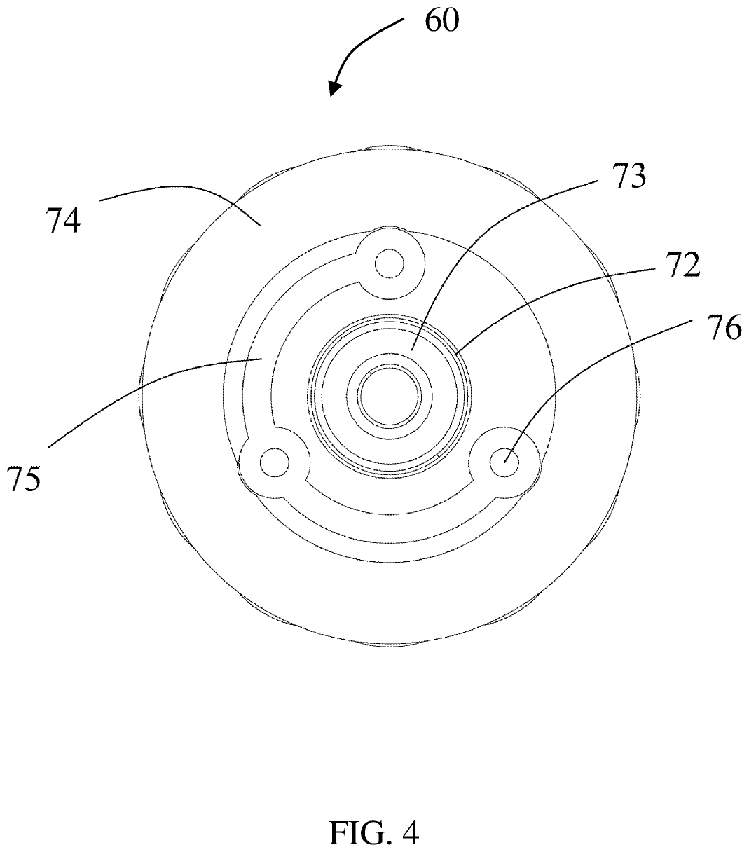

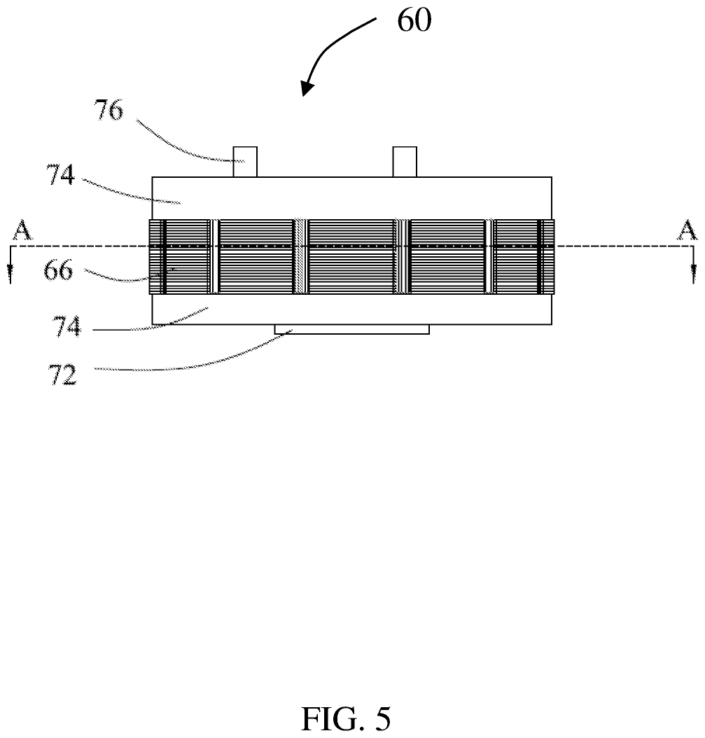

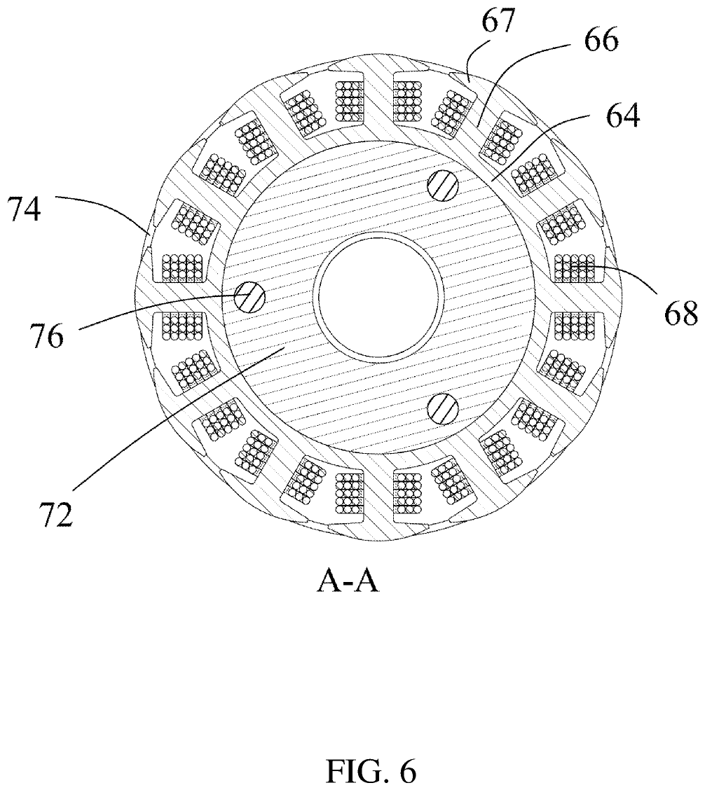

Referring also to FIGS. 3 through 6, the stator 60 includes a magnetic core 62 and a plurality of windings 68. The magnetic core 62 includes a yoke portion 64 and a plurality of teeth 66 projecting outwardly from the yoke portion 64. A distal end of each of the teeth 66 forms a crown 67. The windings 68 are respectively wound on the teeth 66. Since the magnetic core 62 is made of electrically conductive and highly magnetically permeable material and the stator 60 is housed in the outer casing 32 of the rotor 30. The magnetic core 62 with the outer casing 32 cooperatively reduces electromagnetic interference of the windings 68.

The stator 60 also includes two shielding members 74 respectively located and covering opposite axial ends of the magnetic core 62. The shielding members 74 are made of electrically conductive but non-magnetically permeable material, such as copper, or aluminum. Preferably, the shielding members 74 are disk-shaped. The shielding members 74 and the outer casing of the rotor 30 cooperatively form a shielding space for the winding 68. One or more first fasteners 76 extend through the magnetic core 62, and are fixed to both of the shielding members 74. Preferably, the shielding members 74 are in contact with the teeth 66, with the periphery of the shielding members 74 flushing with the radially outer tips of the crowns 67 of the teeth, for better shielding effect. Preferably, at least one of the shielding members 74 is grounded to further enhance the shielding effect. Preferably, the first fasteners 76 are made of electrically conductive material. The magnetic core 62 and the shielding members 74 are electrically coupled through the first fasteners 76 and further grounded for better shielding effect.

In this embodiment, the stator 60 further includes a hollow columnar hub 72 axially extending through and fixed to the center of the magnetic core 62. The rotating shaft 41 extends through the hub 72 and rotatably mounted to hub 72 via one or more bearing 73. The shielding members 74 is located at opposite axial ends of the hub 72. Each of the shielding members 74 defines a though hole aligning with the hub 72. Preferably, the support member 72 is made of non-conductive and non-magnetic, and the first axial connection. Preferably, the support member 72 is made of electrically insulative and non-magnetically permeable material, such as plastics.

The stator 60 also includes a gasket 75 between the shielding members 74 and the first fasteners 76. The first fasteners 76 are electrically connected through the gasket 75, the ensure that both of the shielding members 74 can be properly ground, even if a ground terminal is just connected to one of the shielding members 74, one of the first fasteners 76 or the gasket 75.

In one embodiment, there is a circuit board mounted in the mounting bracket 10. The circuit board is provided with a grounding contact 18, and one of the first fasteners 76 is connected to the ground contact 18 through a wire.

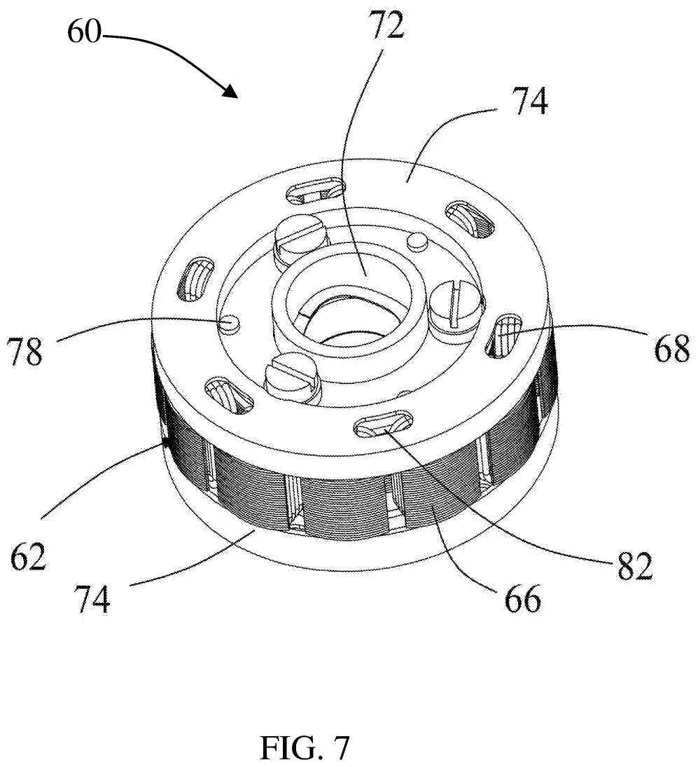

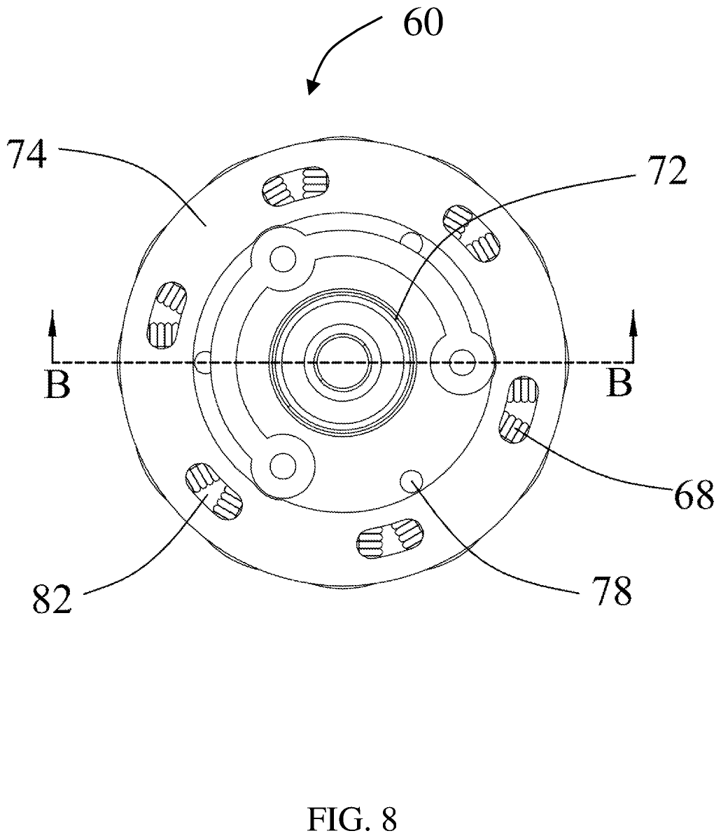

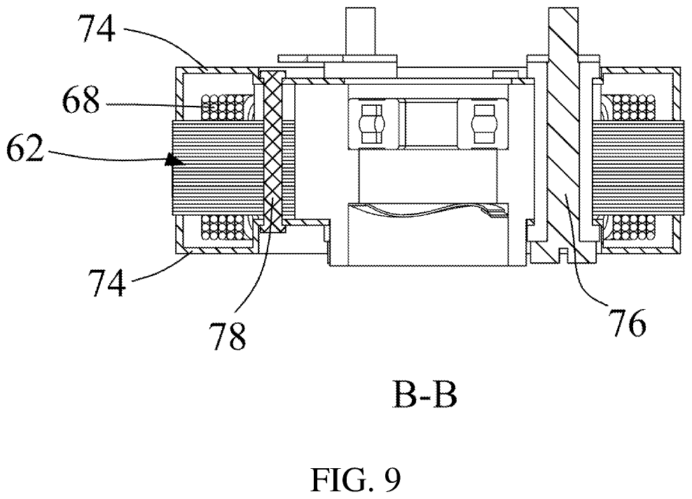

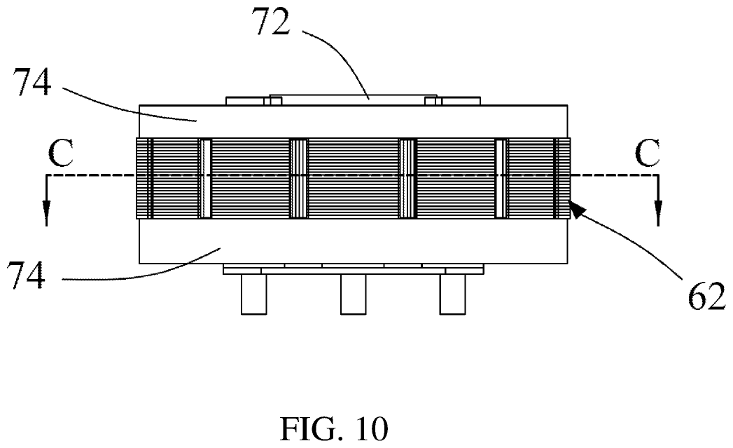

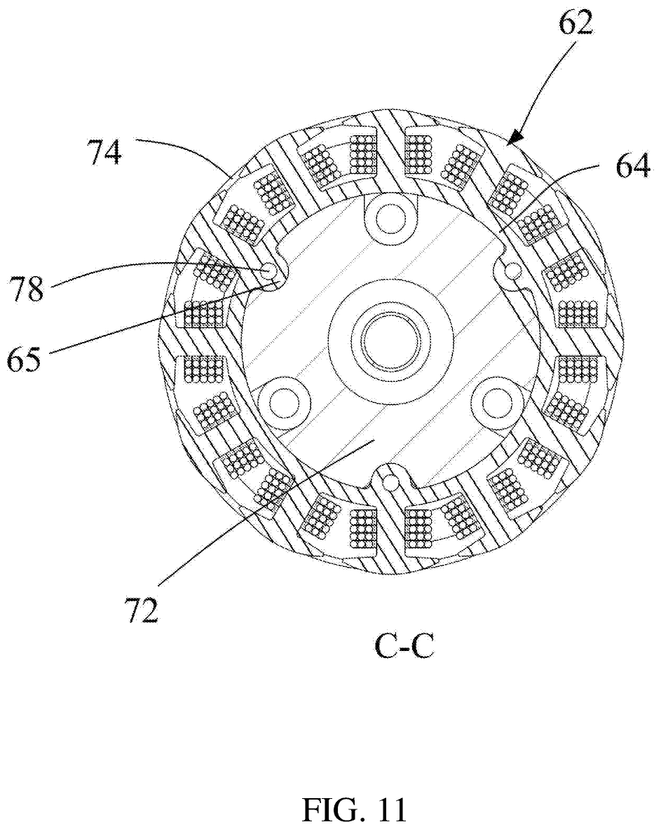

Referring to FIGS. 7 to 11, in a second embodiment, the motor 100 further includes a plurality of second fasteners 78, such as the rivets, to fixedly combination and electrically connection of the magnetic core 62 and the shielding members 74. In details, as shown in FIG. 11, a plurality of tabs 65 protrudes from a circumferential inner side of the yoke portion 64. Each of the tabs 65 defines an axial trough hole. The hub 72 defines a plurality of notches to correspondingly engaged with the tabs 65. The second fasteners 78 correspondingly extend though the axial trough hole of tabs 65 and are fastened to the shielding members 74 to ensure the electrical connection of shielding members 74 and the magnetic core 62. Therefore, when one of the shielding members 74 is grounded, the grounding of the other one shielding member 74 and the magnetic core 62 can be achieved. It can be understood that the first fasteners 76 and the second fasteners 78 can be used alone or in combination.

Each of the shielding members 74 defines a plurality of venting holes 82 exposing the windings 68 for heat dissipation. Preferably, the venting holes 82 are correspondingly aligned with grooves between the adjacent teeth 66, to facilitate heat dissipation of the windings 68 in the grooves, further improving the heat dissipation of the windings 68.

In one embodiment, one of the shielding members 74 covers most of the area of the opening of the outer casing 32. Therefore, the shielding members 74 and the outer casing 32 cooperatively form a complete shielding room, which reduces the electromagnetic interference of the windings 68 caused by the windings 68. Preferably, the mounting bracket 10 defines a cavity 19 that is open at one end, the opening end of the cavity 19 is opposite to the opening end of the outer casing 32. Therefore, the electromagnetic interference of the winding 68 is further reduced, and the electromagnetic compatibility level of the motor 100 is improved.

In one embodiment, the shielding members 74 may be a plastic member coating with a conductive layer. The conductive layer can be a conductive paint sprayed on the surface of the plastic member.

Although the invention is described with reference to one or more embodiments, the above description of the embodiments is used only to enable people skilled in the art to practice or use the invention. It should be appreciated by those skilled in the art that various modifications are possible without departing from the spirit or scope of the present invention. The embodiments illustrated herein should not be interpreted as limits to the present invention, and the scope of the invention is to be determined by reference to the claims that follow.

1. A motor, comprising:
a stator comprising a magnetic core, a plurality of windings, and at least one shielding members mounted to one of opposite ends of the magnetic core, the magnetic core comprising a yoke portion and a plurality of teeth extending from the yoke portion, the windings being correspondingly wound on the teeth, said at least one shielding member being grounded; and
a rotor rotatable to stator, the rotor and said at least one shielding member cooperatively bounding a shielding space for the windings.

2. The motor of claim 1, wherein said at least one shielding member comprises two shielding members respectively fixed to the opposite ends of the magnetic core.

3. The motor of claim 2, wherein the two shielding members are connected to each other with at least one first fastener.

4. The motor of claim 3, wherein the two shielding members are electrically coupled to each other with said at least one first fastener.

5. The motor of claim 4, wherein said at least one first fastener comprises two first fasteners, the stator further comprises a gasket mounted between and electrically coupled to the two first fasteners.

6. The motor of claim 4, wherein said at least one first fastener extends through and electrically coupled to the magnetic core.

7. The motor of claim 1, wherein said at least one shielding member defines a plurality of venting holes exposing the windings for heat dissipation.

8. The motor of claim 1, wherein the stator further comprises a hollow columnar hub axially extending through and fixed to a center of the magnetic core.

9. The motor of claim 4, wherein the motor further comprises a circuit board with a grounding contact, and one of said at least one first fastener is connected to the ground contact through a wire.

10. The motor of claim 4, wherein said at least one shielding member is made of electrically conductive but non-magnetically permeable material.

11. The motor of claim 10, wherein said at least one shielding member is made of copper or aluminum.

12. The motor of claim 10, wherein said at least one shielding member is a plastic member coating with a conductive layer.

13. The motor of claim 1, wherein the motor is an outer rotor brushless DC motor, the rotor comprises an annular outer casing, a plurality of permanent magnets attached to an inner wall of the outer casing, and a rotating shaft fixed to the outer casing, the stator is located in the outer casing and is movably sleeved on the rotating shaft.

14. The motor of claim 13, wherein one end of the outer casing comprises a bottom wall fixed to the rotating shaft, the other end of the outer casing is open to enable the stator fitted into the outer casing therefrom.

15. The motor of claim 14, wherein the motor further comprises a mounting bracket, the stator is fixed to the mounting bracket, the rotating shaft is rotatably mounted to the mounting bracket.

16. The motor of claim 15, wherein the mounting bracket defines a cavity that is open at one end, the opening end of the cavity is opposite to the opening end of the outer casing.

17. An armature of a motor includes a magnetic core comprising a yoke portion and a plurality of teeth extending from the yoke portion,
a plurality of windings correspondingly wound on the teeth, and
at least one shielding member mounted to one of opposite ends of the magnetic core and be grounded.

18. The armature of claim 17, wherein the armature is a stator of a brushless motor.
